(19) United States
(12) Patent Application Publication
(10) Pub. No.: US 2022/0413661 A1
(43) Pub. Date: Dec. 29, 2022

(54) LIST FLOW IMPLEMENTATION METHOD, ELECTRONIC DEVICE, AND STORAGE MEDIUM

(71) Applicant: Beijing Bytedance Network Technology Co., Ltd., Beijing (CN)

(72) Inventors: Shihao JIA, Beijing (CN); Qi ZHANG, Beijing (CN); Li YANG, Beijing (CN); Haoyu WANG, Beijing (CN)

(73) Assignee: Beijing Bytedance Network Technology Co., Ltd., Beijing (CN)

(21) Appl. No.: 17/761,504

(22) PCT Filed: Aug. 28, 2020
(86) PCT No.: PCT/CN2020/112080

§ 371 Date: Mar. 17, 2022

(30) Foreign Application Priority Data
Sep. 20, 2019 (CN) 201910895055.6

(51) Int. Cl. G06F 3/0482; G06F 3/04845; G06F 3/0483; G06F 16/735; G06F 16/738

(52) U.S. Cl. CPC G06F 3/0482; G06F 3/04845; G06F 3/0483; G06F 16/735; G06F 16/738

(57) ABSTRACT

Provided are a list flow implementation method and apparatus, an electronic device, and a storage medium. The method is applied to a client and includes displaying a first list page in the screen display range, where the first list page includes at least two list items; and in response to detecting a first trigger action of a user on one of the at least two list items, switching, in the screen display range, to display a second list page corresponding to the triggered list item. The content recommendation strategy adopted by the second list page is a recommendation strategy determined based on the associated content of the triggered list item.

This application claims priority to Chinese Patent Application No. 201910895055.6 filed with the China National Intellectual Property Administration (CNIPA) on Sep. 20, 2019, the disclosure of which is incorporated herein by reference in its entirety.

### TECHNICAL FIELD

The present disclosure relates to the field of computer technology, for example, a list flow implementation method and apparatus, an electronic device, and a storage medium.

### BACKGROUND

An application (APP), especially an APP that can push consultation, mostly uses a list page to display list items. A user can click a list item of the list page to view the detail page corresponding to the list item. Such a list page can be referred to as feed flow.

Upon clicking a list item of feed flow, the user enters the detail page corresponding to the list item. With this mode, it is difficult to accurately determine and push what interests a new user. As a result, this mode incurs the problem of poor information push accuracy and the problem of low efficiency in acquisition of effective information by a new user. In addition, feed flow, especially comprehensive consultation feed flow, involves a variety of mixed information. Some of such information is unfamiliar to certain users and thus difficult for these users to accept. Thus, it is difficult to promote high-quality information.

### SUMMARY

The present disclosure provides a list flow implementation method and apparatus, an electronic device, and a storage medium to guide users to quickly find target information that interests the users, to improve the accuracy of recommending information to users, and to improve the information acquisition efficiency of users.

The present disclosure provides a list flow implementation method. The method is applied to a client and includes in the screen display range, displaying a first list page, where the first list page includes at least two list items; and in response to detecting a first trigger action of a user on one of the at least two list items, switching, in the screen display range, to display a second list page corresponding to the triggered list item, where a content recommendation strategy adopted by the second list page is a recommendation strategy determined based on the associated content of the triggered list item.

The present disclosure also provides a list flow implementation apparatus. The apparatus includes a first display module and a second display module.

The first display module is configured to display a first list page in the screen display range. The first list page includes at least two list items.

The second display module is configured to, in response to detecting a first trigger action of a user on one of the at least two list items, switch, in the screen display range, to display a second list page corresponding to the triggered list item.

A content recommendation strategy adopted by the second list page is a recommendation strategy determined based on the associated content of the triggered list item.

The present disclosure also provides an electronic device. The apparatus includes one or more processors and a storage apparatus.

The storage apparatus is configured to store one or more programs.

When executed by the one or more processors, the one or more processors cause the one or more processors to implement the list flow implementation method according to any one of embodiments of the present disclosure.

The present disclosure also provides a storage medium including computer-executable instructions which, when executed by a computer processor, cause the computer processor to execute the list flow implementation method according to any one of embodiments of the present disclosure.

### BRIEF DESCRIPTION OF DRAWINGS

FIG. 1 is a flowchart of a list flow implementation method according to embodiment one of the present disclosure;

FIG. 2 is a diagram of a first list page according to embodiment one of the present disclosure;

FIG. 3 is a diagram of a second list page according to embodiment one of the present disclosure;

FIG. 4 is a flowchart of a list flow implementation method according to embodiment two of the present disclosure;

FIG. 5 is a diagram of another second list page according to embodiment two of the present disclosure;

FIG. 6 is a flowchart of a list flow implementation method according to embodiment three of the present disclosure;

FIG. 7 is a diagram illustrating the structure of a list flow implementation apparatus according to embodiment four of the present disclosure; and

FIG. 8 is a diagram illustrating the structure of an electronic device according to embodiment five of the present disclosure.

### DETAILED DESCRIPTION

Embodiments of the present disclosure will be described in detail with reference to the drawings. The drawings illustrate some embodiments of the present disclosure, but it should be understood that the present disclosure may be implemented in various manners and should not be limited to the embodiments set forth herein.

The steps recited in the method embodiments of the present disclosure may be performed in a different order and/or in parallel. In addition, the method embodiments may include additional steps and/or omit execution of illustrated steps.

As used herein, the term “comprise” and variations thereof are intended to be inclusive, that is, “including, but not limited to”. The term “based on” may be “at least partially based on”. The term “an embodiment” may refer to “at least one embodiment”; the term “another embodiment” may refer to “at least one another embodiment”; the term “some embodiments” may refer to “at least some embodiments”.

Concepts such as “first” and “second” in the present disclosure are merely intended to distinguish one from another apparatus, module, or unit and are not intended to limit the order or interrelationship of the functions performed by the apparatus, module, or unit.

It is to be noted that references to modifications of “one” or “a plurality” mentioned in the present disclosure are intended to be illustrative and not limiting.

### Embodiment One

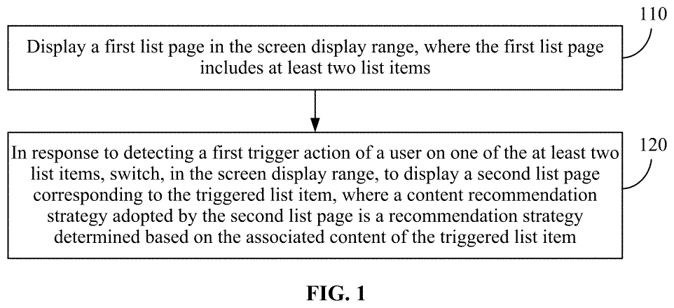

FIG. 1 is a flowchart of a list flow implementation method according to embodiment one of the present disclosure. The method is applied to a client and is applicable to various information push scenarios. The method may be performed by a list flow implementation apparatus. The apparatus may be implemented in the form of at least one of software or hardware and integrated into a terminal, such as a smartphone.

As described in FIG. 1, the list flow implementation method provided in this embodiment includes the following.

In step 110, a first list page is displayed in the screen display range, where the first list page includes at least two list items.

The screen refers to the display screen of a terminal. The screen display range refers to an area where content can be displayed in the display screen. The list item is essentially an information card or information unit, such as a segment of text, a picture, a segment of video, or a segment of audio.

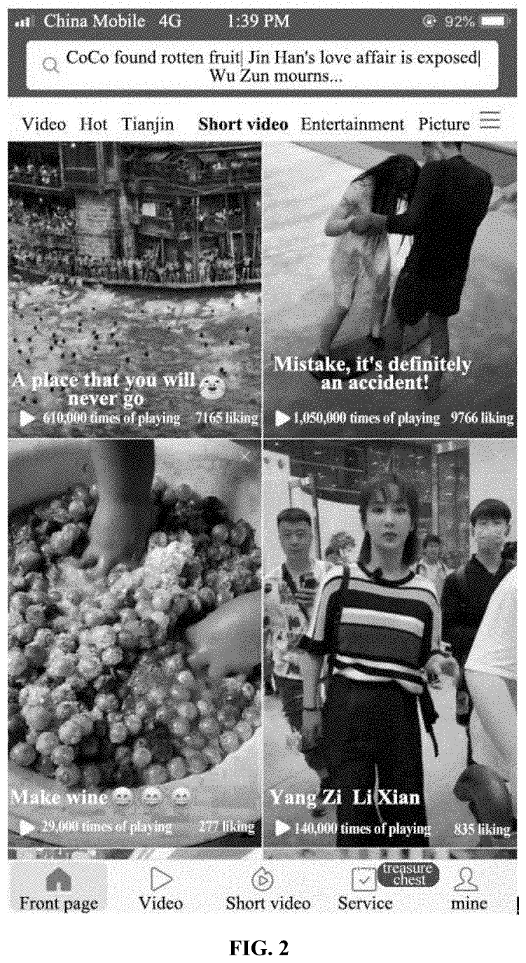

For a new user, interests of the new user cannot be determined due to a lack of historical behavior data of the new user, so a list item of the first list page is generally hot information. While for an old user, a list item that the old user is interested in can be pushed to the old user based on the historical behavior data of the old user. The contents of list items in the first list page in clients of different users are different, but for new users, the contents of list items in the first list page are generally the same in the same time period, and the list items in the first list page are generally hot information in the current time period. Specifically, reference may be made to a diagram of a first list page shown in FIG. 2. The first list page shown in FIG. 2 includes four list items, all of the four list items are video list items, and each list item includes a corresponding cover and a title. Based on the visible information, users can select from a plurality of list items that the users are interested in for detailed viewing. By displaying at least two list items in the first list page, the interests of the users can be captured based on the selection of the users, thereby implementing an object of accurately recommending information for the users.

To quickly capture the interests of the users, at least two types of list items may be displayed in the first list page. The list items may be classified by content. For example, the list items may be classified into a video list item about cooking, a video list item about driving skills, and a video list item about simple stroke drawings. The list items may also be classified by information display form. For example, the list items may be classified into a list item in the form of a picture, a list item in the form of video, and a list item in the form of text.

In step 120, in response to detecting a first trigger action of a user on one of the at least two list items, a switch is performed in the screen display range such that a second list page corresponding to the triggered list item is displayed.

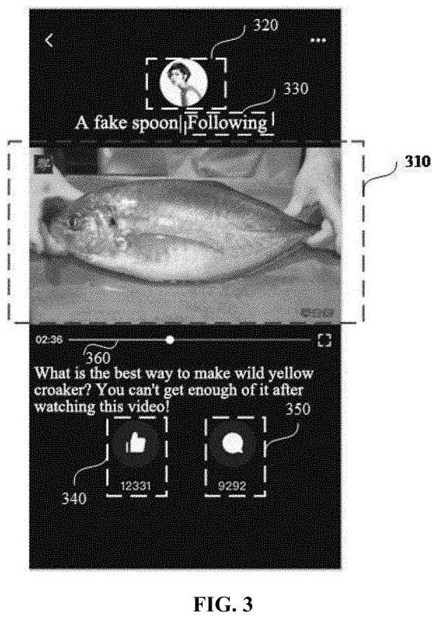

The second list page corresponding to the triggered list item refers to the feed flow associated with the triggered list item. When the first trigger action of the user on one of the at least two list items in the first list page is detected, the detailed content of the triggered list item may be automatically displayed on the second list page. The first trigger action typically includes a click action. When an action of the user to slide the second list page is received, other content associated with the triggered list item may be displayed on the second list page; otherwise, the detailed content of the triggered list item is cyclically displayed. Exemplarily, the triggered list item is a video list item. Referring to a diagram of a second list page shown in FIG. 3, it can be seen from FIG. 3 that a video list item is being played on the second list page. When a sliding up action triggered by a user on the second list page is detected, the next video is played on the second list page, where the next video is a video associated with the triggered list item. When a sliding down action triggered by a user on the second list page is detected, the previous video that has been played is played repeatedly on the second list page. When no action of a user is detected, the video list item that is being played is played cyclically.

The next video is determined by the content recommendation strategy adopted by the second list page. The content recommendation strategy adopted by the second list page is a recommendation strategy determined based on the associated content of the triggered list item. The content recommendation strategy adopted by the second list page is determined based on an internal recommendation strategy of the second list page and within the restriction range of a restriction condition. The restriction condition is an attribute parameter of the triggered list item. The attribute parameter includes at least one of the content category or the publication time. For example, if the publication time of the triggered list item is September 2018, the recommendation strategy may be a strategy for determining the list item with the publication time of September 2018 as the recommendation list item. Alternatively, for example, if the content category of the triggered list item is a video list item about the simple stroke drawings, the recommendation strategy may be a strategy for determining the video list item about the simple stroke drawings as the recommendation list item. The advantage of this arrangement is that the interests of users can be captured in real time based on the operational behavior of users, and the user experience is improved by recommending information to users based on the interests of users. If a user clicks on the video list item about dancing in the first list page, it is considered that the user likes to watch the video content related to dancing. Therefore, more video content about dancing is recommended to the user in the second list page, the high-efficiency push of the high-quality video is implemented, and the attention of the user to the high-quality video is increased, while the user experience is improved.

In some embodiments, to improve the information recommendation accuracy, the content recommendation strategy adopted by the second list page is further determined in combination with the behavior of a user on at least one of the browsing behavior of the user on the triggered list item and the browsing behavior of the user in the second list page. The browsing behavior includes browsing duration, liking, following, or commenting. For example, the triggered list item is a video list item about simple stroke drawings, and more video content about the simple stroke drawings is played on the second list page. The user has the longest viewing time, the highest number of following, and the highest number of liking for the video content about drawing the simple stroke drawings of the small animals played on the second list page, and more video content about drawing the simple stroke drawings of the small animals is recommended to the second list page in subsequent recommendations, so that the second list page plays more video content about the small animals of the simple stroke drawings, thereby achieving an object of getting closer to the interests of users, and improving information recommendation accuracy and user experience.

According to the technical solution of this embodiment of the present disclosure, a first list page is displayed in the screen display range, where the first list page includes at least two list items. In response to detecting a first trigger action of a user on one of the at least two list items, a switch is performed in the screen display range such that a second list page corresponding to the triggered list item is displayed, and content related to the triggered list item is displayed on the second list page, thereby implementing the object of capturing interests of the user in real time based on the trigger action of the user on the triggered list item. Related information is recommended to the user on the second list page based on the interests of the user, thereby, improving information recommendation accuracy and user experience, improving push efficiency of high-quality information, and improving the attention of the user to high-quality information. In particular, this solution facilitates a better recommendation effect of high-quality video content. This is because only the cover or the title information of the video content can be displayed on the first list page, the complete content of the video cannot be played, and in a case where the video content is far different from the cover or the title information, the cover or the title cannot attract the attention of users; and in this case, users have a low acceptance level for such video content, resulting in difficulty in pushing the high-quality video content. In contrast, with the technical solution of this embodiment, the related video content can be directly played on the second list page based on the interest of users captured in real time, thereby increasing the acceptance and attention of users to such video content, and achieving a better push effect.

### Embodiment Two

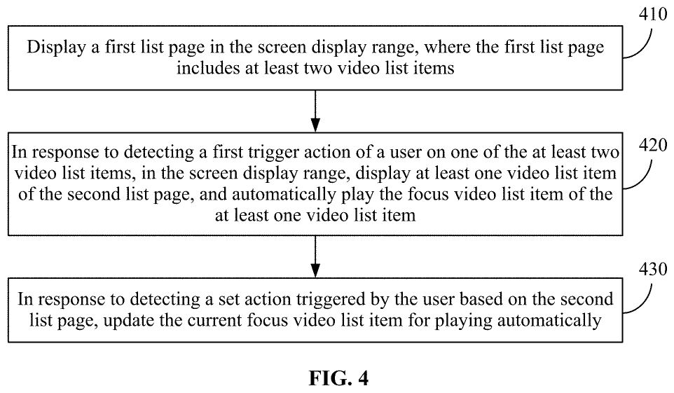

FIG. 4 is a flowchart of a list flow implementation method according to embodiment two of the present disclosure. On the basis of the preceding embodiment, in this embodiment, the triggered list item is a video list item, and the second list page includes one type of list item, that is, the list item included in the second list page is a video list item. The play mode of the video list item on the second list page is designed in detail. The object is to improve the information acquisition efficiency of users.

As shown in FIG. 4, the method includes the following.

In step 410, a first list page is displayed in the screen display range, where the first list page includes at least two video list items.

In step 420, in response to detecting a first trigger action of a user on one of the at least two video list items, at least one video list item of the second list page is displayed in the screen display range, and the focus video list item of the at least one video list item is played automatically.

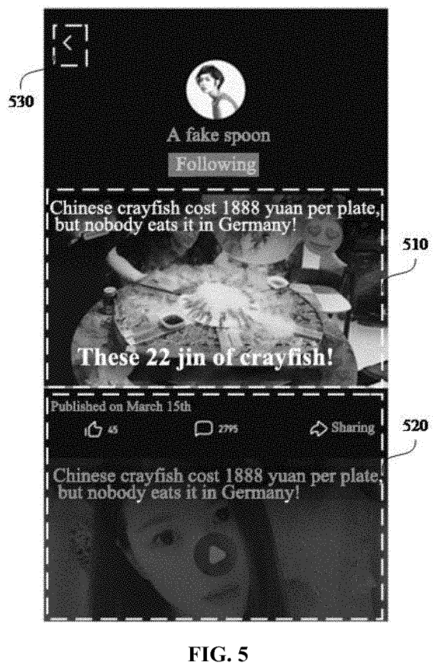

The focus video list item is a video list item of the first complete video window displayed in the screen display range. Alternatively, the focus video list item is a video list item of a complete video window displayed at a set position in the screen display range. The set position may be, for example, the middle position of the screen display range, such as the focus video list item 310 shown in FIG. 3, or the focus video list item 510 shown in FIG. 5. The height of the video window is smaller than the screen height to completely display the video window in the screen display range. Specifically, with reference to the diagram of the second list page shown in FIG. 3 again, the second list page shown in FIG. 3 includes a video list item, and the number 310 denotes a focus video list item. Referring also to the diagram of another second list page shown in FIG. 5, FIG. 5 includes more than one video list item. The number 510 denotes a focus video list item.

In step 430, in response to detecting a set action triggered by the user based on the second list page, the current focus video list item is updated for playing automatically.

The set action may be an action of sliding the second list page. Sliding the second list page up may lead to updating the next video list item to be played to the current focus video list item to play automatically. Sliding the second list page down may lead to updating the previous video list item that has just been played to the current focus video list item to play automatically.

Referring to FIG. 3 again, the second list page also simultaneously shows the avatar 320 of the publisher of the current focus video list item 310 played in the video window, the nickname of the publisher (a fake spoon), the following icon 330, the liking icon and the number of times of liking 340, the commenting icon and the number of times of commenting 350, and the playback progress bar 360 and the playback duration (02:36). As can also be seen from FIG. 3, in some embodiments, a component or control for displaying information related to the current played content may be displayed in a page area outside the playback window. For example, in FIG. 3, whether the avatar 320 of the publisher, the nickname of the publisher (a fake spoon), the following icon 330, the liking icon and the number of times of liking 340, the commenting icon and the number of times of commenting 350, or the playback progress bar 360 and the playback duration (02:36) are displayed outside the video window. This arrangement has the advantage of displaying interference information in the video window as little as possible, so as to ensure the attention of users to the focus video list item 310 and improve the information acquisition efficiency of users.

In some embodiments, if a user slides left or right on the second list page, the user can enter the author flow page of the current focus video list item 310, and all works of the author may be watched on the author flow page.

In another embodiment, switching, in the screen display range, to display the second list page corresponding to the triggered video list item may include the following.

The second list page corresponding to the triggered list item is switched to in the screen display range, where the second list page is displayed in an immersive display mode, and the immersive display mode is a list page display mode in which at least one control in a list page is in a non-interference playback state. The control includes, for example, a “start/pause” control, a progress bar display control, and the like. In the immersive display mode, the control is hidden and is not displayed on the second list page, that is, at least one of the controls is in the non-interference playback state, so as to reduce interference to the current played video, improve the attention of users to the current played video, and further improve the information acquisition efficiency of users and user experience.

In another embodiment, in a case where the triggered list item is a video list item, the second list page is displayed in the immersive display mode in the following manner: in the screen display range, areas excluding a current playback window are displayed in a masked mode, and a next video list item to be played is automatically played after the playback of a video list item that is being played is completed. The page brightness in the masked mode is lower than the page brightness in a non-masked mode.

Referring to a diagram of another second list page shown in FIG. 5, the page area denoted by number 520 is an area displayed in the masked mode. The page brightness of the area displayed in the masked mode is lower than the page brightness in the non-masked mode. The object of displaying areas excluding the current playback window in the masked mode is to minimize interference of other information on the content played by the current playback window, further to ensure the attention of users to the focus video list item 510, and to improve the information acquisition efficiency of users. As can be seen from FIG. 5, the liking icon and the number of times of liking, the commenting icon and the commenting number, and the sharing icon are displayed in the masked mode, but the avatar of the publisher, the nickname of the publisher (a fake spoon), and the following icon of the current focus video list item are retained, so as to facilitate users to acquire information about the publisher.

When the second list page corresponding to the triggered list item is displayed in the immersive display mode, the video window does not display playback controls, for example, the start/pause control. After the playback of the current video is completed, the next video is automatically played. If a user clicks on the video window, the playback is paused, and if the user clicks on the video window again, the playback continues. A “back” button 530 is also displayed on the left of the top of the second list page shown in FIG. 5, and the immersive display mode can be exited through the “back” button 530. When the second list page corresponding to the triggered list item is displayed in the immersive display mode, after the current video plays for a set duration, the title information of the current played video is automatically hidden to reduce interference to the current played video.

According to the technical solution of this embodiment of the present disclosure, a first list page is displayed in the screen display range, where the first list page includes at least two list items. When a first trigger action of a user on one of the at least two list items is detected, the at least one video list item of the second list page is displayed in the screen display range, and the focus video list item of the at least one video list item is played automatically, or the second list page corresponding to the triggered list item is displayed in an immersive display mode, thereby improving the attention of users to the focus video list item and the information acquisition efficiency. For a user who uses an information pushing or an information sharing application client for the first time, or a user who uses such an application client for a small number of times, the information that the user is interested in cannot be accurately determined, and in this case, accurate information recommendation cannot be made for such a user. To solve this problem, this embodiment proposes an implementation of a multi-layer list flow. According to limited user data (for example, a login region of a user, a terminal model used by a user, and the like), a plurality of list items that a user may be interested in are roughly displayed on the homepage of the information pushing or information sharing application client, that is, a first list page (also referred to as an outflow). Then a more precise user interest is determined according to the behavior of a user on the first list page, and a list item of a second list page (also referred to as an inflow) is recommended based on the user interest. To improve the information acquisition efficiency of users, the display mode of the list items in the second list page is specially designed. For example, the list items in the second list page are displayed in an immersive display mode to increase the attention of users to a certain focus list item so that the attention of users is focused on the focus list item, and other information other than the focus list item is not easily perceived by users, thereby improving the information acquisition efficiency of users. Assuming that the display mode of the list items in the first list page is also designed as the immersive display mode, this manner plays a reverse role and reduces the information acquisition efficiency of users. This is because the recommendation accuracy of the list items in the first list page is not high, that is, users have little interest in the list items displayed in the first list page. If the list items are displayed in the immersive display mode in this scenario, the effect of users browsing information in a large area is affected, so that it is not easy for users to quickly find the information that the users may be interested in, thereby reducing the information acquisition efficiency of users. Therefore, in this embodiment, the immersive display mode is not used to display the list items in the first list page, and the list items are displayed in the immersive display mode in the second list page with higher recommendation accuracy, thereby improving the information acquisition efficiency of users.

### Embodiment Three

FIG. 6 is a flowchart of a list flow implementation method according to embodiment three of the present disclosure. On the basis of the above embodiments, the embodiment takes the triggered list item as a video list item as an example, continues to design the play mode of video list items, and introduces a third list page, that is, a full-screen feed flow page. In the third list page, video list items are played in full screen. When one video list item is played, the next video list item to be played is automatically played in full screen, so that users have the maximum attention to the focus video list item, thereby improving the information acquisition efficiency of users.

As shown in FIG. 6, the method includes the following.

In step 710, a first list page is displayed in the screen display range, where the first list page includes at least two list items.

In step 720, in response to detecting a first trigger action of a user on one of the at least two list items, a switch is performed in the screen display range such that a second list page corresponding to the triggered list item is displayed.

A content recommendation strategy adopted by the second list page is a recommendation strategy determined based on the associated content of the triggered list item.

In step 730, in response to detecting a second trigger action of the user on one of list items in the second list page, a switch is performed in the screen display range such that a third list page corresponding to the triggered list item is displayed.

The second trigger action includes a slide-left action or a slide-right action. When a slide-left action or a slide-right action of the user on one of list items in the second list page is detected, a switch is performed in the screen display range such that a third list page corresponding to the triggered list item is displayed.

In another embodiment, the list items in the third list page are determined by the content recommendation strategy adopted by the third list page, and the content recommendation strategy adopted by the third list page is a recommendation strategy determined based on the associated content of the triggered list item of the first list page and the associated content of the triggered list item of the second list page. Specifically, the content recommendation strategy adopted by the third list page is determined based on the internal recommendation strategy of the third list page and within the restriction range of restriction conditions, where the restriction conditions are the attribute parameter of the triggered list item of the first list page and the attribute parameter of the triggered list item of the second list page. The attribute parameter includes at least one of the content category or the publication time. For example, if the publication time of the triggered list item of the first list page is September 2018, and the publication time of the triggered list item of the second list page is Sep. 15, 2018, the content recommendation strategy adopted by the third list page may be a strategy for determining the list item with the publication time of Sep. 15, 2018 as the recommendation list item. Alternatively, for example, if the content category of the triggered list item of the first list page is a video list item about drawing with simple strokes, and the content category of the triggered list item of the second list page is a video list item about drawing small animals with simple strokes, the content recommendation strategy adopted by the third list page may be a strategy for determining the video list item about drawing small animals with simple strokes as the recommendation list item. In this manner, the interests of users can be captured in real time based on the operational behavior of users, and the user experience is improved by recommending information to users based on the interests of users. If a user clicks on the video list item about dancing on the first list page, it is considered that the user likes to watch the video content about dancing, then more video content about dancing is recommended to the user on the second list page. If the user triggers the slide-left action on the video list item about a 16-step dance played on the second list page, it is considered that the user likes to watch the dance video about 16-step dances, then more dance videos about 16-step dances are recommended to the user on the third list page so that the user experience is improved while the high-efficiency push of high-quality video is implemented, and the attention of users to the high-quality video is increased.

To improve the information recommendation accuracy, the content recommendation strategy adopted by the third list page is further determined in combination with at least one of the browsing behavior of a user on the triggered list item or the browsing behavior of a user in the third list page. The browsing behavior includes browsing duration, liking, following, or commenting. For example, if a user has the longest viewing time, the highest number of times of following, and the highest number of times of liking for the dance video content about a 16-step children's dance played on the third list page, then more dance video content about 16-step children's dances is displayed on the third list page, thereby achieving the object of getting closer to the interests of users, and improving information recommendation accuracy and user experience.

In another embodiment, in a case where the second trigger action is a control action for switching a video list item to a video horizontal screen mode, switching, in the screen display range, to display a third list page corresponding to the triggered list item includes the following.

A switch is performed in the screen display range to display a horizontal screen playback window of one video list item of the third list page. After the playback of the video list item played by the current displayed horizontal screen playback window is completed, in the screen display range, a horizontal screen playback window displaying a next video list item to be played is automatically switched to, that is, when a video is played, the next video to be played can be automatically played in full screen. Alternatively, when a set action triggered by a user is received, the video that is currently being played or has been played is slid out of the screen display range so that the next video list item to be played enters the screen display range. Specifically, when a user makes a sliding-up action on the third list page, the video that is currently being played or has been played is slid out of the screen display range so that the next video list item to be played enters the screen display range. When the user makes a sliding-down action on the third list page, the previous video list item that has been played is played again. When the video content in the third list page is played in horizontal screen, the playback control, such as a start/pause control, is not displayed, so as to minimize the interference to the user watching the video, to improve the efficiency of watching the video of users, and further to improve the information acquisition efficiency of users. When a user clicks on the video content played in full screen, the playback of the video content is paused and when the user clicks again, the video content continues to play.

Correspondingly, the content recommendation strategy adopted by the third list page further includes a strategy of acquiring a video list item that meets a horizontal screen playback condition. The horizontal screen playback condition may be configured based on actual requirements, for example, a video whose length is less than the width is determined as a video suitable for playing in a horizontal screen mode. The video content played in the horizontal screen mode does not have a video cover, but the video content is directly played automatically so that users can directly watch the specific video content, so as to implement efficient push of high-quality video and improve the acceptance of users of high-quality videos.

In another embodiment, the second trigger action is a control action for switching to the author flow page corresponding to the triggered list item, and switching, in the screen display range, to display the third list page corresponding to the triggered list item includes switching, in the screen display range, to display the author flow page corresponding to the triggered list item, where the author flow page is a page that displays all list items published by the same author.

According to the technical solution of this embodiment, when it is detected that a user triggers the control action of switching to the video horizontal screen mode based on the second list page, it is considered that the user is very interested in the current video list item of the second list page.

A switch is performed in the screen display range such that the third list page corresponding to the triggered video list item, that is, the full-screen flow page corresponding to the triggered video list item, is displayed. The triggered video list item and video content related to the triggered video list item are played automatically in full screen on the full-screen flow page. Therefore, the attention of users to the video list item and the information acquisition efficiency are improved, and the push of high-quality video content is conducive.

On the basis of the technical solution of above embodiments, in another embodiment, the method further includes that a content recommendation strategy adopted by the first list page is determined based on the history operation behavior of a user on the first list page, the history operation behavior of a user on the second list page, and the history operation behavior of a user on the third list page. That is, when a user has a certain historical operation behavior, the interests of the user may be analyzed based on the historical operation behavior of the user, and the subsequent information recommendation may be performed according to the interests of the user, thereby improving the information acquisition efficiency of users and the user experience.

### Embodiment Four

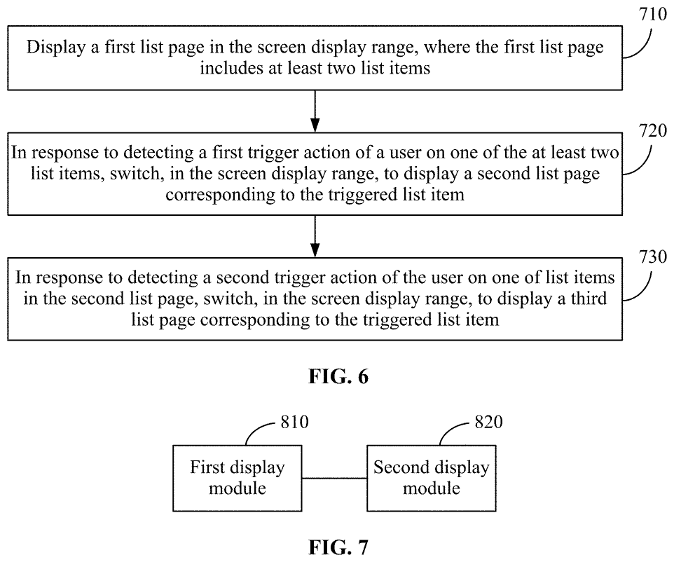

FIG. 7 is a list flow implementation apparatus according to embodiment four of the present disclosure. The apparatus includes a first display module 810 and a second display module 820.

The first display module 810 is configured to display a first list page in the screen display range, where the first list page includes at least two list items. The second display module 820 is configured to, in response to detecting a first trigger action of a user on one of the at least two list items, switch, in the screen display range, to display a second list page corresponding to the triggered list item. A content recommendation strategy adopted by the second list page is a recommendation strategy determined based on the associated content of the triggered list item.

On the basis of the above technical solution, the content recommendation strategy adopted by the second list page is determined based on an internal recommendation strategy of the second list page and within the restriction range of a restriction condition, where the restriction condition is an attribute parameter of the triggered list item.

The attribute parameter includes at least one of the content category or the publication time.

On the basis of the above technical solution, the content recommendation strategy adopted by the second list page is further determined in combination with at least one of the browsing behavior of a user on the triggered list item or the browsing behavior of a user in the second list page.

On the basis of the above technical solution, in a case where the triggered list item is a video list item, the second display module 820 includes a display unit and an update unit.

The display unit is configured to, in the screen display range, display at least one video list item of the second list page and automatically play the focus video list item of the at least one video list item. The focus video list item is a video list item of the first complete video window displayed in the screen display range. Alternatively, the focus video list item is a video list item of a complete video window displayed at a set position in the screen display range.

The update unit is configured to update the current focus video list item for playing automatically in response to detecting a set action triggered by a user based on the second list page.

On the basis of the above technical solution, the second display module 820 is configured to switch, in the screen display range, to a second list page corresponding to the triggered list item. The second list page is displayed in an immersive display mode, and the immersive display mode is a list page display mode in which at least one control in a list page is in a non-interference playback state.

On the basis of the above technical solution, in a case where the triggered list item is a video list item, the second display module 820 is configured to, in the screen display range, display areas excluding the current playback window in a masked mode and automatically play the next video list item to be played after the playback of the video list item that is being played is completed.

The page brightness in the masked mode is lower than the page brightness in a non-masked mode.

On the basis of the above technical solution, the apparatus further includes a third display module. The third display module is configured to switch, in the screen display range, to display the second list page corresponding to the triggered list item and to switch, in the screen display range, to display the third list page corresponding to the triggered list item in response to detecting a second trigger action of a user on one of list items in the second list page.

A content recommendation strategy adopted by the third list page is a recommendation strategy determined based on the associated content of the triggered list item of the first list page and the associated content of the triggered list item of the second list page.

On the basis of the above technical solution, in a case where the second trigger action is a control action for switching a video list item to a video horizontal screen mode, correspondingly, the third display module is configured to switch, in the screen display range, to display a horizontal screen playback window of one video list item of the third list page. Correspondingly, the content recommendation strategy adopted by the third list page further includes a strategy of acquiring a video list item that meets a horizontal screen playback condition.

On the basis of the above technical solution, the third display module is configured to, after the playback of the video list item played by the current displayed horizontal screen playback window is completed, automatically switch to a horizontal screen playback window displaying a next video list item to be played in the screen display range.

On the basis of the above technical solution, the second trigger action is a control action for switching to the author flow page corresponding to the triggered list item, and the third display module is further configured to switch, in the screen display range, to display the author flow page corresponding to the triggered list item. The author flow page is a page that displays all list items published by the same author.

On the basis of the above technical solution, the first trigger action includes a click action, and the second trigger action includes a slide-left action or a slide-right action.

On the basis of the above technical solution, a content recommendation strategy adopted by the first list page is determined based on the history operation behavior of a user on the first list page, the history operation behavior of the user on the second list page, and the history operation behavior of the user on the third list page. The first list page includes at least two types of list items, and the second list page includes one type of list item.

According to the technical solution of this embodiment of the present disclosure, a first list page is displayed in the screen display range, where the first list page includes at least two list items.

In response to detecting a first trigger action of a user on any list item, a switch is performed in the screen display range such that a second list page corresponding to the triggered list item is displayed, and content related to the triggered list item is displayed on the second list page, thereby implementing the object of capturing interests of the user in real time only based on the trigger action of the user on the triggered list item. Related information is recommended to the user on the second list page based on the interests of the user, thereby, improving information recommendation accuracy and user experience, improving push efficiency of high-quality information, and improving the attention of the user to high-quality information. In particular, this solution facilitates a better push effect of high-quality video content. This is because only the cover or the title information of the video content can be displayed on the first list page, the complete content of the video cannot be played, and when the video content is far different from the cover or the title information, the cover or the title cannot attract the attention of users; and in this case, users have a low acceptance level for such video content, resulting in difficulty in recommending the high-quality video content. In contrast, with the technical solution of this embodiment, the related video content can be directly played on the second list page based on the interest of users captured in real time, thereby increasing the acceptance and attention of users to such video content, and achieving a better push effect.

The list flow implementation apparatus provided by this embodiment can execute the list flow implementation method provided by any embodiment of the present disclosure and has functional modules and effects corresponding to the execution method.

It is to be noted that the units and modules involved in the preceding apparatus are just divided according to functional logic, and the division is not limited to this, as long as the corresponding functions can be implemented. In addition, the names of these functional units are just intended to distinguish between these functional units and are not intended to limit the protection scope of the embodiments of the present disclosure.

### Embodiment Five

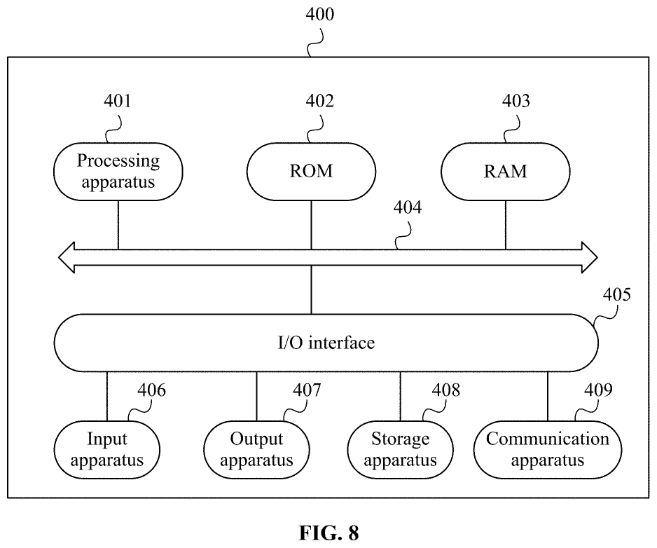

FIG. 8 shows a diagram illustrating the structure of an electronic device 400 for implementing a list flow implementation method provided by this embodiment. The electronic device 400 may be, for example, a terminal apparatus or a server shown in FIG. 8. The terminal device in this embodiment may include, but is not limited to, mobile terminals such as a mobile phone, a laptop, a digital broadcast receiver, a personal digital assistant (PDA), a portable Android apparatus (PAD), a portable media player (PMP), and an in-vehicle terminal (such as an in-vehicle navigation terminal), and stationary terminals such as a digital television (TV) and a desktop computer. The electronic device shown in FIG. 8 is merely an example and is not intended to limit the function and usage scope of this embodiment.

As shown in FIG. 8, the electronic device 400 may include a processing apparatus 401 such as a central processing unit, a graphics processing unit, and the like. The processing apparatus 401 can execute, according to a program stored in a read-only memory (ROM) 402 or a program loaded into a random access memory (RAM) 403 from a storage apparatus 406, various appropriate actions and processing. Various programs and data required for the operation of the electronic device 400 are also stored in the RAM 403. The processing apparatus 401, the ROM 402, and the RAM 403 are connected to each other through a bus 404. An input/output (I/O) interface 405 is also connected to the bus 404.

Generally, the following apparatus may be connected to the I/O interface 405: a touch screen, a touch pad, a keyboard, a mouse, a camera, a microphone, an accelerometer, a gyroscope, and other input apparatuses 406; a liquid crystal display (LCD), a speaker, a vibrator, and other output apparatuses 407; a magnetic tape, a hard disk, and other storage apparatuses 406; and a communication apparatus 409. The communication apparatus 409 may allow the electronic device 400 to perform wireless or wired communication with other devices so as to exchange data. Although FIG. 8 shows the electronic device 400 having various apparatuses, it is to be understood that it is not required to implement or have all the shown apparatuses. Alternatively, more or fewer apparatuses may be implemented or present.

According to this embodiment, the process described above with reference to the flowchart may be implemented through a computer software program. For example, the embodiment of the present disclosure includes a computer program product. The computer program product includes a computer program carried in a non-transitory computer-readable medium. The computer program includes program codes for performing the method shown in the flowchart. In such an embodiment, the computer program may be downloaded from a network and installed through the communication apparatus 409, or may be installed from the storage apparatus 406, or may be installed from the ROM 402. When the computer program is executed by the processing apparatus 401, the preceding functions defined in the method of this embodiment are performed.

The terminal provided in this embodiment belongs to the same concept as the list flow implementation method provided in the above-mentioned embodiment, and for the detailed content not described in detail in this embodiment, reference can be made to the above-mentioned embodiment, and this embodiment has the same beneficial effects as the above-mentioned embodiment.

### Embodiment Six

This embodiment provides a computer storage medium. A computer program is stored on the computer storage medium. When the program is executed by a processor, the list flow implementation method provided in the above-mentioned embodiment is implemented.

The preceding computer storage medium of the present disclosure may be a computer-readable storage medium. The computer-readable storage medium, for example, may include, but is not limited to, an electrical, magnetic, optical, electromagnetic, infrared or semiconductor system, apparatus or apparatus, or any combination thereof. More specific examples of computer-readable storage medium may include, but are not limited to, an electrical connection having one or more wires, a portable computer magnetic disk, a hard disk, a RAM, a ROM, an erasable programmable read-only memory (EPROM) or a flash memory, an optical fiber, a portable compact disc read-only memory (CD-ROM), an optical storage apparatus, a magnetic storage apparatus, or any suitable combination thereof. In the present disclosure, the computer-readable storage medium may be any tangible medium including or storing a program. The program may be used by or used in conjunction with an instruction execution system, apparatus or apparatus. The computer-readable storage medium is a computer-readable medium. The computer-readable medium may further include a computer-readable signal medium. The computer-readable signal medium may include a data signal propagated on a baseband or as a part of a carrier, and computer-readable program codes are carried in the data signal. The data signal propagated in this manner may be in multiple forms and includes, and is not limited to, an electromagnetic signal, an optical signal, or any suitable combination thereof. The computer-readable signal medium may further be any computer-readable medium other than the computer-readable storage medium. The computer-readable signal medium may send, propagate, or transmit a program used by or in conjunction with an instruction execution system, apparatus, or apparatus. The program codes included in the computer-readable medium may be transmitted in any suitable medium, including, but not limited to, a wire, an optical cable, a radio frequency (RF), or any suitable combination thereof.

In some embodiments, clients and servers may communicate using any currently known or future developed network protocol, such as hypertext transfer protocol (HTTP), and may be interconnected with any form or medium of digital data communication (such as a communication network). Examples of the communication network include a local area network (LAN), a wide area network (WAN), an internet (such as the Internet), and a peer-to-peer network (such as an Ad-Hoc network), as well as any currently known or future developed network.

The computer-readable medium may be included in the electronic device or may exist alone without being assembled into the electronic device.

The computer-readable medium carries one or more programs. When the one or more programs are executed by the electronic device, the electronic device is configured to display a first list page in the screen display range, where the first list page includes at least two list items; and in response to detecting a first trigger action of a user on one of the at least two list items, switch, in the screen display range, to display a second list page corresponding to the triggered list item, where a content recommendation strategy adopted by the second list page is a recommendation strategy determined based on the associated content of the triggered list item.

Computer program codes for performing the operations in the present disclosure may be written in one or more programming languages or combination thereof. The preceding one or more programming languages include, but are not limited to, object-oriented programming languages such as Java, Smalltalk and C++, as well as conventional procedural programming languages such as C or similar programming languages. The program codes may be executed entirely on a user computer, partly on the user computer, as a stand-alone software package, partly on the user computer and partly on a remote computer, or entirely on the remote computer or a server. In the scenario involving the remote computer, the remote computer may be connected to the user computer through any type of network, including a local area network (LAN) or a wide area network (WAN), or the connection may be made to an external computer, for example, through the Internet using an Internet service provider.

The flowcharts and block diagrams in the drawings show the possible architecture, function and operation of the system, method and computer program product according to various embodiments of the present disclosure. In this regard, each block in a flowchart or block diagram may represent a module, a program segment, or part of codes. The module, program segment, or part of codes contains one or more executable instructions for implementing specified logical functions. It is also to be noted that in some alternative implementations, the functions in the blocks may occur in sequences different from those shown in the drawings. For example, two successive blocks may in fact be executed substantially in parallel or in a reverse order, which depends on the functions involved. It is also to be noted that each block in the block diagrams and/or flowcharts and a combination of blocks in the block diagrams and/or flowcharts may be implemented by a specific-purpose hardware-based system which performs specified functions or operations or a combination of specific-purpose hardware and computer instructions.

The units involved in this embodiment of the present disclosure may be implemented by software or hardware. The name of a unit is not intended to limit the unit in a certain circumstance, for example, an editable content display unit may also be described as an editing unit.

The functions described above herein may be performed, at least partially, by one or more hardware logic components. For example, without limitation, exemplary types of hardware logic components that may be used include: a field programmable gate array (FPGA), an application specific integrated circuit (ASIC), application specific standard product (ASSP), a system on a chip (SOC), and a complex programmable logic device (CPLD).

In the context of the present disclosure, the computer-readable medium may be a tangible medium, and the computer-readable medium may include or store a program that is used by or in conjunction with a system, apparatus or device that executes instructions.

According to one or more embodiments of the present disclosure, [example 1] provides a list flow implementation method. The method includes displaying a first list page in the screen display range, where the first list page includes at least two list items; and in response to detecting a first trigger action of a user on one of the at least two list items, switching, in the screen display range, to display a second list page corresponding to the triggered list item, where a content recommendation strategy adopted by the second list page is a recommendation strategy determined based on the associated content of the triggered list item.

According to one or more embodiments of the present disclosure, optionally, in a case where the triggered list item is a video list item, switching, in the screen display range, to display a second list page corresponding to the triggered list item includes, in the screen display range, displaying at least one video list item of the second list page, and automatically playing a focus video list item of the at least one video list item; and in response to detecting a set action triggered by a user based on the second list page, updating the current focus video list item for playing automatically.

According to one or more embodiments of the present disclosure, optionally, the focus video list item is a video list item of the first complete video window displayed in the screen display range; or the focus video list item is a video list item of a complete video window displayed at a set position in the screen display range.

According to one or more embodiments of the present disclosure, optionally, switching, in the screen display range, to display a second list page corresponding to the triggered list item includes switching, in the screen display range, to a second list page corresponding to the triggered list item, where the second list page is displayed in an immersive display mode. The immersive display mode is a list page display mode in which at least one control in a list page is in a non-interference playback state.

According to one or more embodiments of the present disclosure, optionally, in a case where the triggered list item is a video list item, the second list page is displayed in an immersive display mode in the following manner: in the screen display range, areas excluding a current playback window are displayed in a masked mode, and a next video list item to be played is automatically played after the playback of a current played video list item is completed, where the page brightness in the masked mode is lower than the page brightness in a non-masked mode.

According to one or more embodiments of the present disclosure, optionally, after switching, in the screen display range, to display a second list page corresponding to the triggered list item, the method further includes in response to detecting a second trigger action of a user on one of list items in the second list page, switching, in the screen display range, to display a third list page corresponding to a triggered list item, where a content recommendation strategy adopted by the third list page is a recommendation strategy determined based on the associated content of the triggered list item of the first list page and the associated content of the triggered list item of the second list page.

According to one or more embodiments of the present disclosure, optionally, in a case where the second trigger action is a control action for switching a video list item to a video horizontal screen mode, switching, in the screen display range, to display a third list page corresponding to the triggered list item includes switching, in the screen display range, to display a horizontal screen playback window of one video list item of the third list page.

According to one or more embodiments of the present disclosure, optionally, switching, in the screen display range, to display the third list page corresponding to the triggered list item further includes, after the playback of the video list item played by the current displayed horizontal screen playback window is completed, automatically switching, in the screen display range, to a horizontal screen playback window displaying a next video list item to be played.

According to one or more embodiments of the present disclosure, optionally, a content recommendation strategy adopted by the third list page further includes a strategy of acquiring a video list item that meets a horizontal screen playback condition.

According to one or more embodiments of the present disclosure, optionally, the second trigger action is a control action for switching to the author flow page corresponding to the triggered list item; and switching, in the screen display range, to display the third list page corresponding to the triggered list item includes switching, in the screen display range, to display the author flow page corresponding to the triggered list item, where the author flow page is a page that displays all list items published by the same author.

According to one or more embodiments of the present disclosure, optionally, the first trigger action includes a click action, and the second trigger action includes a slide-left action or a slide-right action.

According to one or more embodiments of the present disclosure, optionally, a content recommendation strategy adopted by the first list page is determined based on the history operation behavior of a user on the first list page, the history operation behavior of the user on the second list page, and the history operation behavior of the user on the third list page.

According to one or more embodiments of the present disclosure, optionally, a content recommendation strategy adopted by the second list page is determined based on an internal recommendation strategy of the second list page and within the restriction range of a restriction condition, wherein the restriction condition is an attribute parameter of the triggered list item.

The attribute parameter includes at least one of the content category or the publication time.

According to one or more embodiments of the present disclosure, optionally, a content recommendation strategy adopted by the second list page is further determined in combination with at least one of the browsing behavior of a user on the triggered list item or the browsing behavior of a user in the second list page.

According to one or more embodiments of the present disclosure, optionally, the first list page includes at least two types of list items, and the second list page includes one type of list item.

According to one or more embodiments of the present disclosure, [example 2] provides a list flow implementation apparatus. The apparatus includes a first display module and a second display module.

The first display module is configured to display a first list page in the screen display range. The first list page includes at least two list items.

The second display module is configured to, in response to detecting a first trigger action of a user on one of the at least two list items, switch, in the screen display range, to display a second list page corresponding to a triggered list item.

A content recommendation strategy adopted by the second list page is a recommendation strategy determined based on the associated content of the triggered list item.

According to one or more embodiments of the present disclosure, [example 3] provides an electronic device. The electronic device includes one or more processors and a storage apparatus.

The storage apparatus is configured to store one or more programs.

When executed by the one or more processors, the one or more programs cause the one or more processors to implement the list flow implementation method as described below.

A first list page is displayed in the screen display range, where the first list page includes at least two list items.

In response to detecting a first trigger action of a user on one of the at least two list items, a second list page corresponding to the triggered list item is switched to display in the screen display range.

A content recommendation strategy adopted by the second list page is a recommendation strategy determined based on the associated content of the triggered list item.

According to one or more embodiments of the present disclosure, [example 4] provides a storage medium including computer-executable instructions. When executed by a computer processor, the computer-executable instructions cause the computer processor to execute the list flow implementation method as described below.

A first list page is displayed in the screen display range, where the first list page includes at least two list items.

In response to detecting a first trigger action of a user on one of the at least two list items, a second list page corresponding to the triggered list item is switched to display in the screen display range.

A content recommendation strategy adopted by the second list page is a recommendation strategy determined based on the associated content of the triggered list item.

Although the operations are depicted in a particular order, this should not be construed as requiring that such operations should be performed in the particular order shown or in a sequential order. In certain circumstances, multitasking and parallel processing may be advantageous.

Similarly, although specific implementation details are included in the above discussion, these should not be construed as limiting the scope of the present disclosure. Some features described in the context of separate embodiments may also be implemented in combination in a single embodiment. Conversely, various features described in the context of a single embodiment may also be implemented in multiple embodiments, individually or in any suitable sub-combination.

Although the subject matter is described in the language specific to structural features and/or methodological logic acts, it is to be understood that the subject matter defined in the appended claims is not necessarily limited to the specific features or acts described above. Conversely, the specific features and acts described above are merely example forms of implementing the claims.

1. A list flow implementation method, the method being applied to a client and comprising:
displaying a first list page in a screen display range, wherein the first list page comprises at least two list items; and
in response to detecting a first trigger action of a user on one list item of the at least two list items, switching, in the screen display range, to display a second list page corresponding to the triggered list item, wherein
a content recommendation strategy adopted by the second list page is a recommendation strategy determined based on an associated content of the triggered list item.

2. The method according to claim 1, wherein in a case where the triggered list item is a video list item, switching, in the screen display range, to display the second list page corresponding to the triggered list item comprises:
in the screen display range, displaying at least one video list item of the second list page and automatically playing a focus video list item of the at least one video list item; and
in response to detecting a set action triggered by the user based on the second list page, updating a current focus video list item for playing automatically.

3. The method according to claim 2, wherein the focus video list item is a video list item of a first complete video window displayed in the screen display range; or
the focus video list item is a video list item of a complete video window displayed at a set position in the screen display range.

4. The method according to claim 1, wherein switching, in the screen display range, to display the second list page corresponding to the triggered list item comprises:
switching, in the screen display range, to the second list page corresponding to the triggered list item, wherein the second list page is displayed in an immersive display mode, and the immersive display mode is a list page display mode in which at least one control in a list page is in a non-interference playback state.

5. The method according to claim 4, wherein in a case where the triggered list item is a video list item, the second list page is displayed in the immersive display mode in the following manner:
in the screen display range, areas excluding a current playback window are displayed in a masked mode, and a next video list item to be played is automatically played after a playback of a current played video list item is completed, wherein
a page brightness in the masked mode is lower than a page brightness in a non-masked mode.

6. The method according to claim 1, after switching, in the screen display range, to display the second list page corresponding to the triggered list item, the method further comprising:
in response to detecting a second trigger action of the user on one list item of the second list page, switching, in the screen display range, to display a third list page corresponding to the triggered list item of the second list page, wherein
a content recommendation strategy adopted by the third list page is a recommendation strategy determined based on the associated content of the triggered list item of the first list page and an associated content of the triggered list item of the second list page.

7. The method according to claim 6, wherein in a case where the second trigger action is a control action for switching a video list item to a video horizontal screen mode, switching, in the screen display range, to display the third list page corresponding to the triggered list item comprises:
switching, in the screen display range, to display a horizontal screen playback window of one video list item of the third list page.

8. The method according to claim 7, wherein switching, in the screen display range, to display the third list page corresponding to the triggered list item further comprises:
after a playback of a video list item played by a current displayed horizontal screen playback window is completed, automatically switching, in the screen display range, to display a horizontal screen playback window of a next video list item to be played.

9. The method according to claim 7, wherein the content recommendation strategy adopted by the third list page further comprises a strategy of acquiring a video list item that meets a horizontal screen playback condition.

10. The method according to claim 6, wherein in a case where the second trigger action is a control action for switching to an author flow page corresponding to the triggered list item, switching, in the screen display range, to display the third list page corresponding to the triggered list item comprises:
switching, in the screen display range, to display the author flow page corresponding to the triggered list item, wherein
the author flow page is a page that displays all list items published by a same author.

11. The method according to claim 6, wherein the first trigger action comprises a click action, and the second trigger action comprises a slide-left action or a slide-right action.

12. The method according to claim 6, wherein a content recommendation strategy adopted by the first list page is determined based on a history operation behavior of the user on the first list page, a history operation behavior of the user on the second list page, and a history operation behavior of the user on the third list page.

13. The method according to claim 1, wherein
the content recommendation strategy adopted by the second list page is determined within a restriction range of a restriction condition, wherein the restriction condition is an attribute parameter of the triggered list item.

14. The method according to claim 13, wherein
the attribute parameter comprises at least one of a content category or a publication time.

15. The method according to claim 13, wherein
the content recommendation strategy adopted by the second list page is further determined in combination with at least one behavior of a browsing behavior of the user on the triggered list item or a browsing behavior of the user in the second list page.

16. The method according to claim 1, wherein the first list page comprises at least two types of list items, and the second list page comprises one type of list item.

17. (canceled)

18. An electronic device, comprising:
one or more processors; and
a storage apparatus configured to store one or more programs, wherein
when executed by the one or more processors, the one or more programs cause the one or more processors to implement the following steps:
displaying a first list page in a screen display range, wherein the first list page comprises at least two list items; and
in response to detecting a first trigger action of a user on one list item of the at least two list items, switching, in the screen display range, to display a second list page corresponding to the triggered list item, wherein
a content recommendation strategy adopted by the second list page is a recommendation strategy determined based on an associated content of the triggered list item.

19. A non-transitory storage medium, comprising computer-executable instructions which, when executed by a computer processor, cause the computer processor to execute the following steps:
displaying a first list page in a screen display range, wherein the first list page comprises at least two list items; and
in response to detecting a first trigger action of a user on one list item of the at least two list items, switching, in the screen display range, to display a second list page corresponding to the triggered list item, wherein
a content recommendation strategy adopted by the second list page is a recommendation strategy determined based on an associated content of the triggered list item.

20. The method according to claim 2, after switching, in the screen display range, to display the second list page corresponding to the triggered list item, the method further comprising:
in response to detecting a second trigger action of the user on one list item of the second list page, switching, in the screen display range, to display a third list page corresponding to the triggered list item of the second list page, wherein
a content recommendation strategy adopted by the third list page is a recommendation strategy determined based on the associated content of the triggered list item of the first list page and an associated content of the triggered list item of the second list page.

21. The method according to claim 3, after switching, in the screen display range, to display the second list page corresponding to the triggered list item, the method further comprising:
in response to detecting a second trigger action of the user on one list item of the second list page, switching, in the screen display range, to display a third list page corresponding to the triggered list item of the second list page, wherein
a content recommendation strategy adopted by the third list page is a recommendation strategy determined based on the associated content of the triggered list item of the first list page and an associated content of the triggered list item of the second list page.
